(19) United States
(12) Patent Application Publication
(10) Pub. No.: US 2025/0084596 A1
(43) Pub. Date: Mar. 13, 2025

(54) CONTROLLING INCLINATION OF A MACHINE USING NON-CONTACT SENSORS

(71) Applicant: Caterpillar Paving Products Inc., Brooklyn Park, MN (US)

(72) Inventors: Eric S. Engelmann, Delano, MN (US); Conwell K. Rife, JR., Hanover, PA (US)

(73) Assignee: Caterpillar Paving Products Inc., Brooklyn Park, MN (US)

(21) Appl. No.: 18/811,359

(22) Filed: Aug. 21, 2024

Related U.S. Application Data
(60) Provisional application No. 63/537,178, filed on Sep. 7, 2023.

(51) Int. Cl. E01C 23/088; E01C 23/12; G01C 9/00

(52) U.S. Cl. CPC E01C 23/088; E01C 23/127; E01C 2301/00; G01C 9/00

(57) ABSTRACT

A work machine can include a frame defining a front end and a rear end of the work machine. The frame can have a frame axis and a rotating drum extending in a direction perpendicular through the frame axis. The work machine can include a transportation device to move the work machine over a ground surface. The work machine can include a lifting column extending between the frame and the transportation device and side plates arranged on opposite sides of the work machine. The work machine can include at least one sensor, which can detect a feature of the ground surface.

### CLAIM OF PRIORITY

This application claims the benefit of U.S. Provisional Patent Application Ser. No. 63/537,178, filed on Sep. 7, 2023, the benefit of priority of which is claimed hereby, and which is incorporated by reference herein in its entirety.

### TECHNICAL FIELD

The present disclosure generally relates to the field of construction. More particularly, the present disclosure relates to inclination control for work machines.

### BACKGROUND

Cold planer machines and rotary mixer machines can be used to remove old or degraded pavement from surfaces such as roadways and parking lots. These and other construction machines can traverse uneven terrain. It may be desirable to control the machine to operate parallel or at a controllable incline relative to the cut or uncut surface. Previous solutions detected the angle between legs of the work machine and the tracked undercarriages that connect the legs. By controlling that angle, operators can control the attitude of the machine relative to the surface the undercarriages are riding on (e.g., the ground).

U.S. Pat. No. 8,424,972 describes a road milling machine having controls to establish the parallel orientation of the machine frame relative to the ground surface.

### SUMMARY

In an example, a work machine can include a frame, a transportation device, a lifting column, side plates, at least one sensor, and a controller. The frame defines a front end and a rear end of the work machine and has a frame axis extending longitudinally therethrough and a rotating drum extending in a direction perpendicular through the frame axis. The transportation device is configured to move the work machine over a ground surface. The lifting column extends between the frame and the transportation device. The side plates are arranged on opposite sides of the work machine. The at least one sensor is located laterally outside a width of the work machine defined by the side plates. The sensor is configured to detect a feature of the ground surface. The controller is coupled to the at least one sensor and configured to control the lifting column to control inclination of the work machine based on the detected feature.

In an example, an inclination control system can include at least one sensor adapted to be positioned laterally outside a cut width of a work machine, the at least one sensor configured to detect a feature of a cut plane under the work machine. The inclination control system can include a controller adapted to be coupled to the sensor and configured to control inclination of the work machine based on the detected feature.

In an example, a method can include detecting a feature of a ground surface using at least one sensor arranged laterally outside a width of a work machine defined by side plates on opposite sides of the work machine, and controlling a lifting column to control inclination of the work machine based on the detected feature.

In an example, a work machine can include a frame, a transportation device, a lifting column, side plates, at least one non-contacting sensor, and a controller. The frame defines a front end and a rear end of the work machine and has a frame axis extending longitudinally therethrough and a rotating drum extending in a direction perpendicular through the frame axis. The transportation device is configured to move the work machine over a ground surface. The lifting column extends between the frame and the transportation device. The side plates are arranged on opposite sides of the work machine. The at least one non-contacting sensor is located on a central axis of the work machine and configured to detect a feature of the ground surface between the side places. The controller is coupled to the one or more non-contacting sensors and configured to control the lifting column to control inclination of the work machine based on the detected feature.

In an example, a method can include detecting a feature of a ground surface using at least one non-contacting sensor located on a longitudinal central axis of a work machine between side plates on opposite sides of the work machine; and controlling a lifting column to control inclination of the work machine based on the detected feature.

These and other examples and features of the present devices, systems, and methods will be set forth in part in the following Detailed Description. This overview is intended to provide a summary of subject matter of the present patent application. It is not intended to provide an exclusive or exhaustive removal of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a side view of a construction machine including an inclination control system, in accordance with at least one example.

FIG. 2A illustrates placement of non-contacting sensors according to one embodiment.

FIG. 2B illustrates an example non-contacting sensor that can be placed according to FIG. 2A.

FIG. 3 illustrates placement of a dual non-contacting sensor system according to embodiments.

FIG. 4 illustrates a rear view of a work machine including non- contacting sensors according to embodiments.

FIG. 5 illustrates a side view of a work machine to illustrate a belt guard according to embodiments.

FIG. 6 is a side view of a work machine before the inclination control system has been used to correct inclination of the frame, in accordance with at least one example.

FIG. 7 is a computer system on which example embodiments can be implemented.

### DETAILED DESCRIPTION

During the milling of roadways and other pavement surfaces a work machine may be made to operate parallel (or at another predefined angle or incline) relative to the cut or uncut work surface. By operating parallel to the work surface, certain operational metrics can be maximized. For example, the amount of front leg travel (or freedom of movement of the front leg) can be maximized to allow control of cutting depth and cutting depth adjustments. Furthermore, operator comfort can be enhanced by maintaining the work machine parallel to the work surface. Still further, conveyor clearance or other parameters can be maximized or enhanced by controlling the machine to keep a positive inclination (e.g., the front end higher than the rear end). Conveyor clearance can be important when loading trucks or performing similar operations.

In the context of embodiments, “pitch” refers to the rotation of a work machine about the transverse axis, “roll” is the rotation of a work machine about the longitudinal axis, “attitude” and “inclination” refer to the three-dimensional orientation of a vehicle with respect to a specified reference frame. A vehicle frame can be considered “parallel” to the ground when a horizontal plane through a center axis of the vehicle is tilted by less than 5 degrees, or less than 1 degree, or at zero +/−0.5% incline relative to the ground.

To perform inclination control, the work machine should be able to sense or detect a surface (e.g., the ground, a work surface, a road surface etc.) beneath the work machine. Systems and apparatuses according to embodiments provide sensors to detect this surface as described below.

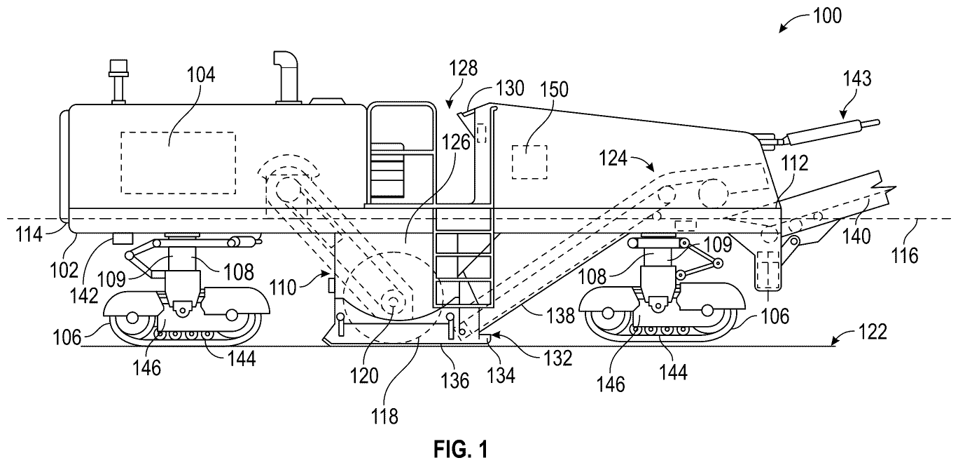

FIG. 1 is a side view of a work machine 100, which in the illustrated example is a cold planer machine. The cold planer machine 100 includes a frame 102 to which a power source 104 and transportation devices 106 can be connected. Transportation devices 106 can be connected to the frame 102 via lifting columns 108. In at least one example, the transportation devices 106 can include the lifting columns 108, such that controlling the transportation devices 106 can include controlling the lifting columns 108. A milling assembly 110 can, for example, be coupled to the underside of the frame 102 between the transportation devices 106.

The frame 102 longitudinally extends between a first (e.g., front) end 112 and a second (e.g., rear) end 114 along a frame axis 116. The power source 104 can be provided in any number of different forms including, but not limited to, Otto and Diesel cycle internal combustion engines, electric motors, hybrid engines and the like. Power from the power source 104 can be transmitted to various components and systems of machine 100, such as the transportation devices 106 and a milling drum 118 (e.g., a rotating drum).

The frame 102 can be supported by the transportation devices 106 via lifting columns 108. Each of the transportation devices 106 can be any kind of ground-engaging device that allows the cold planer machine 100 to move over a ground surface, for example a paved road or a ground already processed by the cold planer machine 100. The transportation devices 106 can be coupled to the frame by legs 109. A leg 109 can be considered a part of the lifting column 108, for example a part that extends from the machine frame 102 and attaches to a respective transportation device 106. In the illustrated example, the transportation devices 106 are configured as track assemblies, each of which includes a track 144 and a track frame 146 around which the track 144 rotates. A non-contacting sensor or sensors 142 can detect features of the surface 122 or other surfaces as described in more detail below. The transportation devices 106 can be configured to move the cold planer machine 100 in forward and backward directions along the ground surface in the direction of the axis 116. The lifting columns 108 can be configured to raise and lower the frame 102 relative to the transportation devices 106 and the ground.

The milling assembly 110 can include the rotatable milling drum 118 operatively connected to the power source 104. The milling drum 118 can include a plurality of cutting tools, such as chisels, disposed thereon. The milling drum 118 can be rotated about a drum or housing axis 120 extending in a direction perpendicular to the frame axis 116 into the plane of FIG. 1. As the rotatable milling drum 118 spins or rotates about the drum axis 120, the cutting tools may engage hardened materials 122, such as, for example, asphalt and concrete, of existing roadways, bridges, parking lots and the like. Moreover, as the cutting tools engage such hardened materials 122, the cutting tools remove layers of these hardened materials 122. The spinning action of the rotatable drum 118 and its cutting tools can then transfer the hardened materials 122 to a conveyor system 124.

The milling assembly 110 can further include a drum housing 126 forming a chamber for accommodating the milling drum 118. The drum housing 126 can include front and rear walls, and a top cover positioned above the milling drum 118. Furthermore, the drum housing 126 can include lateral covers, or side plates, on the left and right sides of the milling drum 118 with respect to a travel direction of the cold planer machine 100. The drum housing 126 can be open toward the ground so that the milling drum 118 can engage the ground from the drum housing 126. Furthermore, the drum housing 126 can be removed from the frame 102 for maintenance, repair, and transport.

The cold planer machine 100 can further include an operator station or platform 128 including an operator interface 130 for inputting commands to a controller 150 for controlling the cold planer machine 100, and for outputting information related to an operation of the cold planer machine 100. As such, an operator of the cold planer machine 100 can perform control and monitoring of functions of the cold planer machine 100 from the platform 128, such as by observing various data output by sensors located on the cold planer machine 100. Furthermore, the operator interface 130 can include controls for operating the transportation devices 106 and the lifting columns 108.

An anti-slabbing system 132 can be coupled to the drum housing 126 and can include an upwardly oriented base plate (not visible in FIG. 1) extending across a front side of the cutting chamber, a forwardly projecting plow 134 for pushing loose material lying upon the hardened materials 122, and a plurality of skids 136. The conveyor system 124 can include a primary conveyor 138 and a secondary conveyor 140. The primary conveyor 138 can be positioned forward of the milling drum 118 and can be coupled to and supported upon the base plate of the anti-slabbing system 132. The primary conveyor 138 can feed material cut from the hardened materials 122 via the milling drum 118 to the secondary conveyor 140 projecting forward of the frame end 112. A positioning mechanism 143 can be coupled to the secondary conveyor 140, to enable left, right, up, and down position control of the secondary conveyor 140. The secondary conveyor 140 can deposit removed hardened materials 122 into a receptacle, such as the box of a dump truck.

The cold planer machine 100 can include further components not shown in the drawings, which are not described in further detail herein. For example, the cold planer machine 100 can further include a fuel tank, a cooling system, a milling fluid spray system, various kinds of circuitry, etc. Additionally, although the present application is described with reference to a cold planer machine including a milling drum, the present invention is applicable to other types of work machines.

The cold planer machine 100 can drive over the hardened materials 122 such that the front transportation devices 106 roll over the hardened materials 122. The cold planer machine 100 can be configured to remove the hardened materials 122 from a roadway to leave a planed surface behind. In some examples, the rear transportation devices 106 can roll on the planed surface, with the milling assembly 110 producing an edge of the hardened material 122 between milled and un-milled surfaces of the hardened material 122. The milled surface can include a surface from which paving material has been completely removed or a surface of paving material from which an upper-most layer of paving material has been removed, or a surface comprising material mixed by the milling assembly 110.

The cold planer machine 100 can be configured to travel in a forward direction (from left to right with reference to FIG. 1) to remove the hardened materials 122. The anti-slabbing system 132 can travel over the top of the hardened materials 122 to prevent or inhibit the hardened materials 122 from becoming prematurely dislodged during operations for removal of the hardened materials 122. The milling drum 118 can follow behind the anti-slabbing system 132 to engage the hardened materials 122. The milling drum 118 can be configured to rotate counter-clockwise with reference to FIG. 1 such that material of the hardened materials 122 can be uplifted and broken up into small pieces by cutting teeth or chisels of the milling drum 118. The anti-slabbing system 132 can be configured to contain pieces of the hardened materials 122 within the drum housing 126. Removed pieces of the hardened materials 122 can be pushed up the primary conveyor 138 and carried forward, such as by an endless belt, to the secondary conveyor 140. The secondary conveyor 140 can be cantilevered forward of the front frame end 112 to be positioned over a collection vessel, such as the box of a dump truck. While the illustrated example is described with reference to an up cutting machine, the present teachings are applicable to a down cutting machine as well.

During the course of moving over the hardened materials 122, the transportation devices 106 can encounter obstacles, protrusions, or slopes which are rolled over by the transportation devices 106. Such obstacles, protrusions, or slopes can cause the cold planer machine 100 to tilt in one or more directions. In at least one example, the work machine 100 can include an inclination control system to determine inclination of the work machine 100 such that the controller 150 can control the work machine 100 to compensate for the inclination.

Inclination control systems according to example embodiments include non-contacting Light Detection and Ranging (LIDAR) sensors (or other types of laser sensors), smart cameras (or other imaging system), sonic sensors, other types of line-of-sight sensors, or other sensors that can analyze features of the ground surface to determine features of the ground plane. In some examples, these non-contacting sensors can detect distance from the sensor to the ground (or other surface). Based on the distance or features of the ground plane, a controller or processing circuitry can determine the inclination angle of the work machine and adjust accordingly if needed. For example, the inclination control system can extend or retract one or more lifting column/s to correct the angle between the longitudinal axis 116 of the machine 100 and the ground plane or surface.

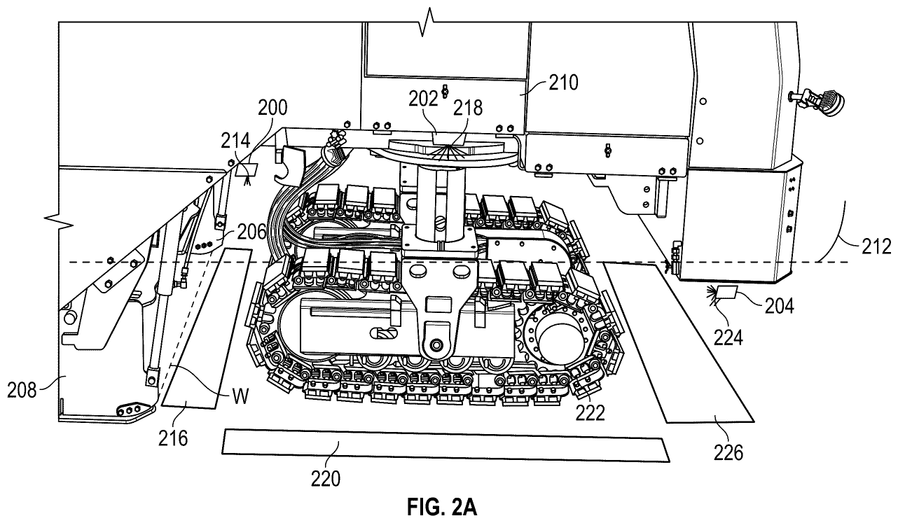

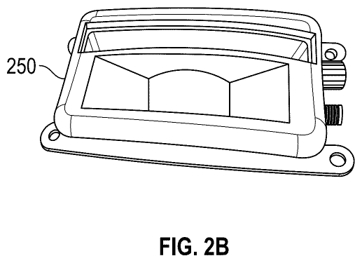

FIG. 2A illustrates placement of non-contacting sensors 200, 202, 204 according to one embodiment. FIG. 2B illustrates an example non-contacting sensor 250 that can be placed according to FIG. 2A. An inclination control system according to embodiments can include a controller (which can be incorporated in the controller 150 (FIG. 1) or incorporate separate processing circuitry) coupled to one or more ground sensors 200, 202, 204. With reference to FIG. 2B, one or more of the ground sensors 200, 202, 204 can include a LIDAR based system 250, although other laser-based devices/sensors, sonic-based sensors, cameras, or other devices capable of measuring distance to an object or analyzing a surface can be used.

The non-contacting sensors 200, 202, 204 described herein can detect features of the ground surface or distance from the non-contacting sensor to the ground surface. A plane can be established by sensing an array (e.g., at least two) of distances within the viewing area. For example, the controller 150 can use the detected distances to define a plane, and mathematical or geometric algorithms can be used to compute an angle of the machine 100 relative to the defined plane. The controller 150 can infer information related to forward-aftward tilting (pitch), side-to-side tilting (roll), or both, of the work machine 100. In some examples, information from two or more non-contacting sensors can be compared to determine an orientation of the work machine 100.

Referring to FIG. 2A, the non-contacting sensors 200, 202, 204 can be provided in one or more locations. For example, side plates 206, 208 may be arranged on machine frame 210 on opposite sides of a milling drum (e.g., drum 118 (FIG. 1), not shown in FIG. 2A). Side plates 206, 208 can provide edge protectors at an outer wall of the work machine and may rest on the ground or traffic surface at the lateral non-milled edges of a milling track. Side plates 206, 208 can define a width dimension W. A non-contacting sensor 200 can be placed outside the side plate 208 (e.g., away from a center axis 212 of the work machine or outside the width defined by side plates 206, 208) such that the distance from the side plate 208 to the center axis 212 is smaller than the distance from the non- contacting sensor 200 to the center axis. The non-contacting sensor 200 can be mounted to the frame 210, or to a surface (e.g., outer surface) of the side plate 206, outside a side plate ski (not shown in the figure), or other location or placement.

A sensing signal 214 can be provided from the non-contacting sensor 200 to scan and define a ground plane in a longitudinal direction within a sensing area 216 below the sensor 200. In embodiments, the signal 214 may sense inwardly toward the center axis 212 or directly downward, or outward away from the center axis 212, or any other controllable or pre-configured direction. The sensing area 216 can be inside the cut path of the work machine as determined by the space (e.g., width W) between the side plates 206, 208, or outside the cut path (e.g., in an uncut area laterally away from the work machine 100). In examples, the sensor 200 can determine, calculate, or detect the distance from the sensor 200 to the ground plane within area 216, among other parameters.

Additional sensors or alternative sensor placements can be used. For example, a sensor (similar to sensor 202 but not shown in FIG. 2A) can be or could be provided on an opposite side of the axis 212, for example on the frame 210 and outside the width W defined by the side plates 206, 208). Similar to sensing signal 214, a sensing signal 218 can be provided from the non-contacting sensor 202 to measure distance or other parameters within an area 220 below the sensor 202. In embodiments, the signal 218 may sense directly downward, or outward away from the work machine 100, or in any other controllable or pre-configured direction. The sensor 202 can be placed outside the side plate 208 (e.g., away or further (relative to the side plate 208) from the center axis 212 of the work machine) such that the distance from the side plate 208 to the center axis 212 is smaller than the distance from the non-contacting sensor 202 to the center axis 212.

In addition or as an alternative to sensors 200, 202, a sensor 204 can be provided on an opposite side of tracks 222 relative to the side plates 206, 208. A sensing signal 224 can be provided from the non-contacting sensor 204 to measure distance or other parameters within an area 226 below the sensor 204. In embodiments, the signal 224 may sense directly downward, or inwardly toward the tracks 222, or outward away from the center axis 212, or in any other controllable or pre-configured direction. The sensor 204 can be placed outside the side plate 208 (e.g., away from a center axis 212 of the work machine) such that the distance from the side plate 208 to the center axis 212 is smaller than the distance from the non-contacting sensor 204 to the center axis 212.

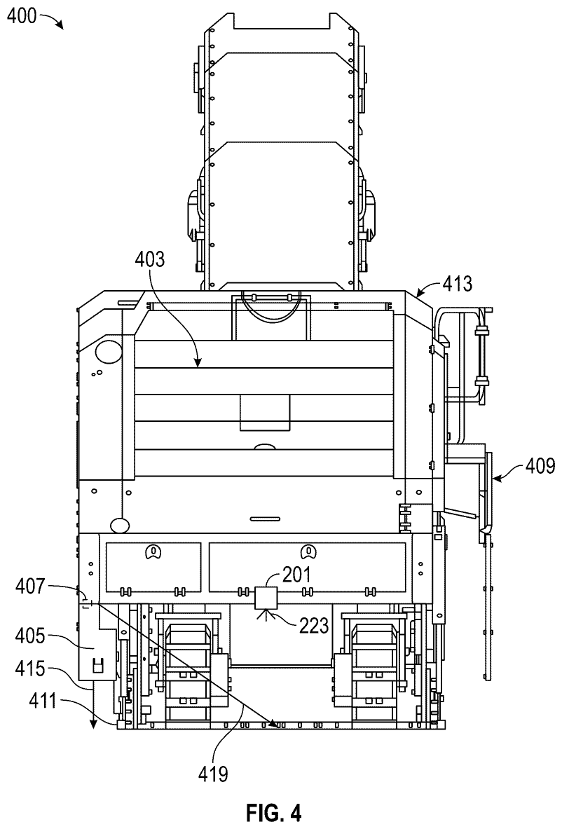

In another example, a pair of non-contacting sensors 201, 203 (similar to sensors 200 and/or 204 not shown in FIG. 2A but sensor 201 is shown in FIG. 4) can be located forward and rearward of tracks 222 on or near a center axis of work machine 100. The center axis can be a centrally located axis extending longitudinally through work machine 100, e.g. center axis 212. Additionally, the central axis can be defined by the center cut axis of the drum of work machine 200. In an example, the center axis near or at which the pair of non-contacting sensors are located a longitudinal axis centered laterally between the tracks 222 and/or the lifting columns connected to the tracks 222.

Sensing signals 223 (see FIG. 4) can be provided from such non-contacting sensors 201, 203 to measure distance or other parameters within one or more areas below the sensors and between the tracks 222. In embodiments, the signals 223 may sense downward and outwardly away from the center axis 212, or in any other controllable or pre-configured direction. The sensing areas can be, for example, inside the cut path of the work machine as determined by the space (e.g., width W) between the side plates 206, 208. In this example, the sensing area or areas of the pair of centrally located non-contacting sensors 201, 203 can be between the tracks 222. For example, an elongated sensing area for each of sensor 201, 203 is along a central axis and laterally constrained between the tracks 222. In examples, the pair of non-contacting sensors 201, 203 can determine, calculate, or detect the distance from the sensors to the ground plane within area(s) between tracks 222, among other parameters. In an example, the centrally located pair of non-contacting sensors are sonic sensors, including, e.g., ultrasonic sensors.

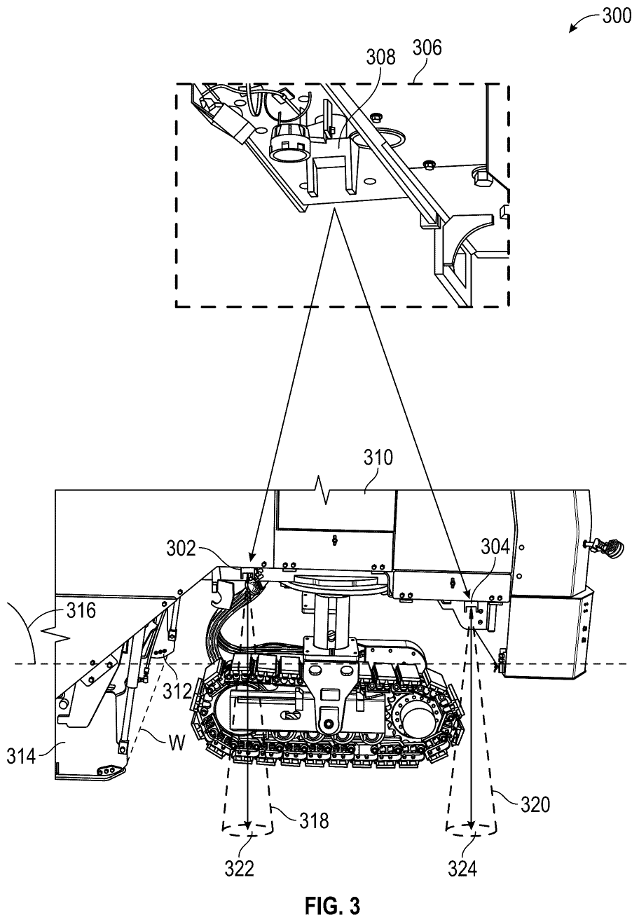

FIG. 3 illustrates placement of a dual non-contacting sensor system 300 according to embodiments. Dual sensors 302, 304 can be spaced longitudinally to sense inclination. Inset 306 illustrates example mounting of a sensor 308 (wherein sensor 308 is same or similar to one of the dual sensor 302, 304) below the frame 310 of a work machine 100. The dual sensors 302, 304 can include any type of system capable of detecting distance to an object (e.g., to the ground plane). The dual sensors 302, 304 may or may not be of the same sensor type.

Side plates 312, 314 may be arranged on machine frame 310 on opposite sides of a milling drum (e.g., drum 118 (FIG. 1), not shown in FIG. 3) to define a width W between the side plates (wherein the width W may be referred to as a cut width). As described earlier herein, side plates 312, 314 can provide edge protectors at an outer wall of the work machine and may rest on the ground or traffic surface at the lateral non-milled edges of a milling track. The dual sensors 302, 304 can be placed outside the side plate 314 (e.g., away from a center axis 316 of the work machine) such that the distance from the side plate 314 to the center axis 316 is smaller than the distance from each sensor 302, 304 to the center axis.

Sensing signals 318, 320 can be provided from the dual sensors 302, 304, respectively to measure distance from the sensors 302, 304 to the ground plane. In embodiments, the signals 318, 320 may sense inwardly toward the center axis 316 or directly downward, or any other controllable or pre-configured direction. In examples, similar dual sensors (not shown in FIG. 3) can be provided outside (e.g., further from the sensor axis) relative to side plate 312. The signal 318 can detect an area 322 and the signal 320 can detect an area 324.

The dual sensors 302, 304 can communicate to a controller, which can be incorporated within or separate from the controller 150 (FIG. 1). Based on distances to the ground plane measured by dual sensors 302, 304, the controller 150 can determine characteristics of the work machine 100, including, e.g., the inclination of the work machine relative to ground. In an example, the controller 150 can determine whether or not the work machine is parallel to the ground based on distances to the ground plane measured by dual sensors 302, 304. For example, given that the dual sensors 302, 304 are each mounted or installed at a known point on the frame 310 at a nominal distance from the ground, the measurements captured by each of the dual sensors 302, 304 can be used to calculate the incline or attitude of the work machine 100. By way of illustration, if sensor 302 is mounted at a point X millimeters above the sensor 304, then the work machine 100 is level if the sensor 302 detects a distance to the ground surface X millimeters greater than the distance measure by the sensor 304. On the other hand, if the sensor 302 detects a distance to the ground surface that is not X millimeters greater than the distance measure by the sensor 304, then the controller 150 can detect that the work machine 100 is tilted either forward or aftward based on the sensor measurements.

FIG. 4 illustrates a rear view of a work machine 400 to illustrate alternative placement of a non-contacting sensor 407 (in FIG. 407 should point to red box I added in marked up) according to embodiments. In the example, the work machine 400 includes a grill 403 extending across the width of the work machine. A belt guard 405 is provided on the left side of the work machine 400. An enclosure 413 and ladder 409 are provided on the right side of the work machine 400. A non-contacting sensor 407 can be mounted laterally between a plane created by the outside surface of the belt guard 405 and plane created by the surface of the side plate 411. The non-contacting sensor 407 can detect downwardly as shown with signal 419 or inwardly as shown with signal 415 Need diff number and also fix on DWGs. More than one non-contacting sensor can be provided. For example, at least two non-contacting sensors can be provided spaced longitudinally to measure relative heights from the ground plane as described above with respect to FIG. 3.

Work machine 400 includes a pair of non-contacting sensors 201, 203 (only sensor 201 is visible in this view), which can be located forward and rearward of the tracks of the work machine on or near a center axis of the machine. The center axis can be a centrally located axis extending longitudinally through work machine 400. Additionally, the central axis can be defined by the center cut axis of the drum of work machine 400. In an example, the center axis near or at which the pair of non-contacting sensors 201, 203 are located is a longitudinal axis centered laterally between the tracks and/or the lifting columns connected to the tracks.

Sensing signals 223 can be provided from such non-contacting sensors 201, 203 to measure distance or other parameters within one or more areas below the sensors and between the tracks. For example, an elongated sensing area for each sensor is along a central axis and laterally constrained between the tracks. In examples, the pair of non-contacting sensors 201, 203 can determine, calculate, or detect the distance from the sensors to the ground plane within the sensing area(s) between tracks 222, among other parameters. In an example, the centrally located pair of non-contacting sensors 201, 203 are sonic sensors, including, e.g., ultrasonic sensors.

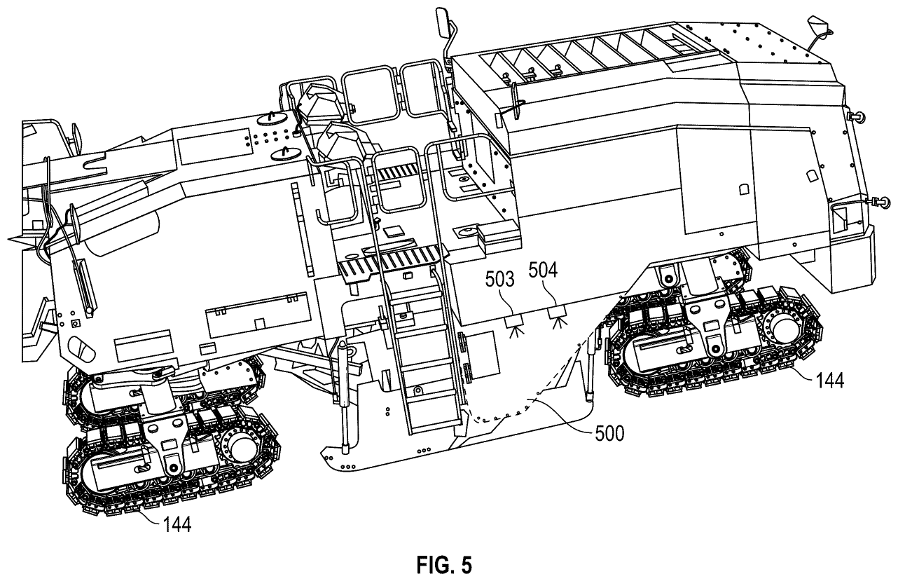

FIG. 5 illustrates a side view of a work machine to illustrate a belt guard 500 (which can be similar to the belt guard 405 (FIG. 4)) according to embodiments. Dual sensors 503, 504 can be spaced longitudinally behind the belt guard 500 and configure and used in a similar fashion as described above with reference to FIG. 3. In another example, dual sensors 503, 504 can be spaced longitudinally apart from one another toward the bottom of belt guard 500. In examples, dual sensors 503, 504 can be spaced closer together, longitudinally, than described with reference to FIG. 3. This may increase the sensitivity of height measurement. The dual sensors 503, 504 can include any type of system capable of detecting distance to an object (e.g., to the ground plane). The dual sensors 503, 504 may or may not be of the same sensor type.

Sensing signals can be provided from the dual sensors 503, 504, respectively to measure distance from the sensors 503, 504 to the ground plane. In embodiments, the signals may sense inwardly or directly downward, or any other controllable or pre-configured direction.

The dual sensors 503, 504 can communicate to a controller which can be incorporated within or separate from the controller 150 (FIG. 1). Based on distances to the ground plane measured by dual sensors 503, 504, the controller 150 can determine characteristics of the work machine 100, including, e.g., the inclination of the work machine relative to ground. In an example, the controller 150 can determine whether or not the work machine is parallel to the ground based on distances to the ground plane measured by dual sensors 503, 504. For example, given that the dual sensors 503, 504 are each mounted or installed at a known or nominal distance from the ground, the measurements captured by each of the dual sensors 503, 504 can be used to calculate the incline or attitude of the work machine 100. By way of illustration, if sensor 503 is mounted at a point X millimeters above the sensor 504, then the work machine 100 is level if the sensor 503 detects a distance to the ground surface X millimeters greater than the distance measure by the sensor 504.

In some embodiments, other sensors within linear actuators, or within the transportation device/s 106 can be compared or used in conjunction with the non-contacting sensors described in FIG. 2A, 2B, 3 and 5 to adjust the work machine 100 to maintain the frame 102 of the machine parallel to the cut plane. In at least one example, the controller 150 adjusts the work machine 100 to maintain the frame 102 parallel to the track of the transportation device 106. In some examples, the operator may choose to operate the work machine 100 at an incline or a decline, in which case the inclination control system can be used to maintain the frame 102 of the work machine 100 at a predetermined offset from parallel to the operating surface.

The controller 150 can use information from the non-contacting sensors described above in conjunction with other machine information, for example steering data, to control tilting or inclination of the cold planar machine 100 relative to the operating surface. In at least one example, one or more non-contacting sensor/s can be used to control the cut plane of the milling drum 118 by controlling the orientation of the milling drum 118. In at least one example, one or more non-contacting sensor/s can be used to keep the cold planer machine 100 level for cutting. In at least one example, the controller 150 uses the inclination information or distance-to-ground information to adjust (e.g., extend or retract) one or more of the lifting columns 108. In at least one example, the inclination control system including the one or more non-contacting sensor/s can be used to control the stability of the work machine 100 when moving over a bump or other obstacle or when moving between surfaces of different heights.

In some examples the inclination control system only detects and/or corrects for side-to-side tilt or roll. In some examples, the inclination control system only detects and corrects for forward-aftward tilt or pitch. In some examples, the inclination control system detects and/or corrects forward-aftward tilt (pitch) and side-to-side tilt (roll). In some examples, the inclination control system detects and/or corrects for any deviation from parallel to the cut plane. For example, if the frame of the work machine 100 is not parallel to the cut plane, the inclination control system will detect this and correct the work machine such that the frame is parallel to the cut plane. In at least one example, the inclination control system uses geographical data of the operating surface to keep the frame parallel to the cut plane. In at least one example, the inclination control system detects and/or corrects in real time. For example, the inclination control system can detect and/or control the orientation of the work machine 100 relative to the cut plane to provide the desired cut, to provide an even cut, to provide a smooth ride for the operator, to avoid other unfavorable operational conditions of the work machine 100, a combination of these, or the like.

Referring again to FIG. 1, based on the inclination measurement determined by the controller 150, the controller 150 adjusts (extends or retracts) one or more of the lifting columns 108. Since each lifting column 108 corresponds to a transportation device 106 the controller 150 can identify and select the one or more lifting columns 108 that need to be adjusted to correct the inclination or tilt of the work machine 100. For example, if non-contacting sensors of an inclination control system are provided on both sides of the work machine 100, and if the inclination control system indicates that the work machine 100 is not parallel to the cut surface due to a side-to-side tilt such that the right side is lower than the left side, the controller 150 can extend the right side lifting columns 108 (corresponding to right side transportation devices 106) to raise the right side relative to the left side, or the controller 150 can retract the left side lifting columns 108 (corresponding to left side traveling deices 106) to lower the left side relative to the right side of the work machine 100.

Similarly, if the inclination control system indicates that the work machine 100 is not parallel to the cut surface due to a forward-aftward tilt such that the rear end is higher than the front end, the controller 150 can extend the front end lifting columns 108 (corresponding to front end transportation devices 106) to raise the front end relative to the rear end, or the controller 150 can retract the rear end lifting columns 108 (corresponding to rear end transportation devices 106) to lower the rear end relative to the front end of the work machine 100. In some examples, the inclination control system may indicate tilts or inclinations in both the fore-aft and side-to-side directions. In at least one example, the inclination control system only corrects for forward-aftward tilt.

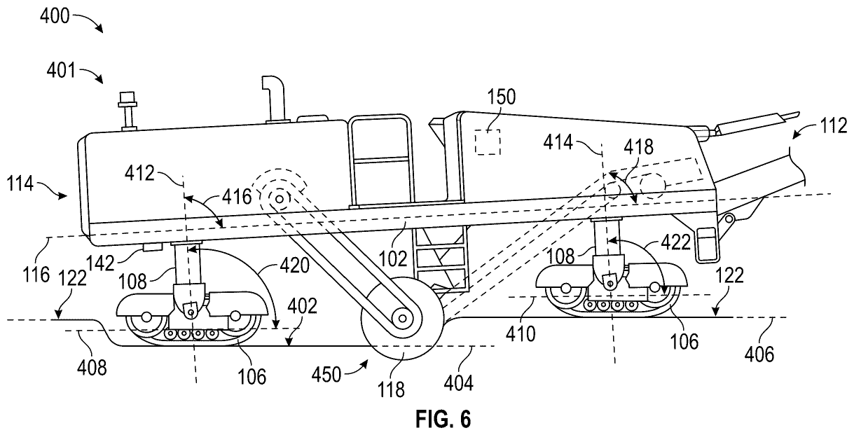

FIG. 6 is a side view of a work machine 400 before the inclination control system of example embodiments has been used to correct inclination of the frame 102, in accordance with at least one example. In the illustrated example, the work machine 400 is a milling machine, for example a cold planer. The front and rear transportation devices 106 began on the ground surface or hardened material 122 and began milling by plunging the milling drum 118 into the hardened material 122 to create an operating surface 402. The transportation devices 106 move or transport the milling machine 400 over the ground surface.

Immediately after the plunge, the front and rear transportation devices 106 remain on the hardened material 122 straddling the operating surface 402. As the milling machine 400 advances, the front transportation devices 106 continue moving on the hardened material 122, while the rear transportation devices 106 drop into the depression created by the milling drum. This depression can be seen in the difference between the operating surface 402 and the plane 406 of the hardened material 122. In the illustrated example the rear transportation devices 106 are positioned on the operating surface 402 in a depression relative to the front transportation devices 106, which are positioned on the hardened material 122 that has not yet been milled by the milling drum 118. As a result, the rear portion of the milling machine 400 is lower relative to the front portion of the milling machine 400, such that the front portion of the milling machine 400 is pitched up (nose-up) and the frame axis 116 is at an incorrect orientation relative to the operating surface 402 and the corresponding cut plane 404. The incorrect orientation in such cases is generally an orientation such that the frame 102 is at an angle relative to (non-parallel) to the cut plane 404.

In the illustrated example, this has resulted in the milling drum 118 deviating from the cut plane 404 to gouge 450 or otherwise cut deeper than the desired depth and create an uneven surface. In conventional systems, the milling machine might include automatic controls that raise the lifting columns 108 of the front transportation device 106 so as to avoid a gouge 450 and to maintain the milling drum 118 cutting along the operating surface 402. However, such automatic adjustments result in an even more significant nose-up pitch of the frame 102 and can reduce the available range of adjustment of the lifting columns 108 or legs 109 of the front transportation devices 106 (i.e., they may not be able to extend further when necessary, limiting their ability to be adjusted to control the milling drum 118 or for other reasons). This extreme nose-up pitch of the frame 102 can also result in a portion of the side plates (e.g., see FIG. 1) lifting off the ground, which will interfere with the side plates' role in providing a ground reference.

Finally, a frame 102 that is at a pitch (nose-up or nose-down) can result in an uncomfortable experience for the operator of the milling machine 400. As such, even for milling machines that would avoid a gouge 450 during a plunge into a depression, the present inclination control system would be beneficial to maintain the frame 102 parallel to the cut plane 404 at least to allow for maximum range of adjustment of the front lifting cylinders, to provide a more comfortable experience for the operator, to avoid a gouge cut 450, and to avoid lifting a portion of the side plates off of the ground.

The lifting columns 108 are coupled to the frame 102 at a fixed angle 416, 418 (in the illustrated example, 90 degrees), but are pivotably coupled to the transportation devices 106. As such, when the rear transportation devices 106 move from the hardened surface 122 to the depressed operating surface 402, the lifting columns 108 pivot relative to the transportation devices 106, to a first angle 420, 422 (depicted using axes 412, 414 of the lifting columns 108 and axes 408, 410 of the transportation devices 106). The inclination control system 401 uses non-contact sensors (e.g., sensors 200, 202, 204 (FIG. 2A), sensors 302, 304 (FIG. 3) sensor 407 (FIG. 4) or sensors 503, 504 (FIG. 5)) to detect features of the operating surface 402 or distance to the operating surface 402. In some examples one or more non-contacting sensors as described above can be positioned near, above, or proximate a rear transportation device 106 although embodiments are not limited thereto. In the illustrated example, based on the sensed information from the non-contact sensors, the controller 150 determines that the frame axis 116 is not parallel to the operating surface 402 and the front of the milling machine 400 is pitched up (nose-up). Similarly, the controller 150 could determine that the front of the milling machine 400 is pitched down (nose-down).

The controller 150 can extend or retract the rear lifting columns 108 to correct the angle 420. For example, the controller 150 can extend the rear lifting columns 108 if the front of the machine 400 is pitched up and lower the lifting columns 108 if the front of the machine 400 is pitched down. In other examples, the controller 150 could extend or retract one or more of the front lifting columns 108 instead of or in addition to the rear lifting columns 108. In some examples, the milling machine 400 can include four transportation devices 106, for example right rear, left rear, right front, left front. In other examples, the milling machine 400 can include three transportation devices 106, for example rear, right front, left front. Any or all of the transportation devices 106 can have non-contacting sensors at or proximate respective transportation devices 106 to detect whether the frame axis 116 is parallel to the operating surface 402.

In at least one example, the inclination system checks whether the frame axis 116 is parallel to the operating surface 402 during the adjustment of the lifting column/s 108 to determine when to stop the lifting column 108 based on detected distance to the operating surface 402 or detected features of the operating surface 402. In some examples, the inclination system 401 continuously checks the non-contacting sensor data in real time. In at least one example, the controller 150 can determine the precise adjustment required based on detected actual distance to the operating surface 402 or features of the operating surface 402.

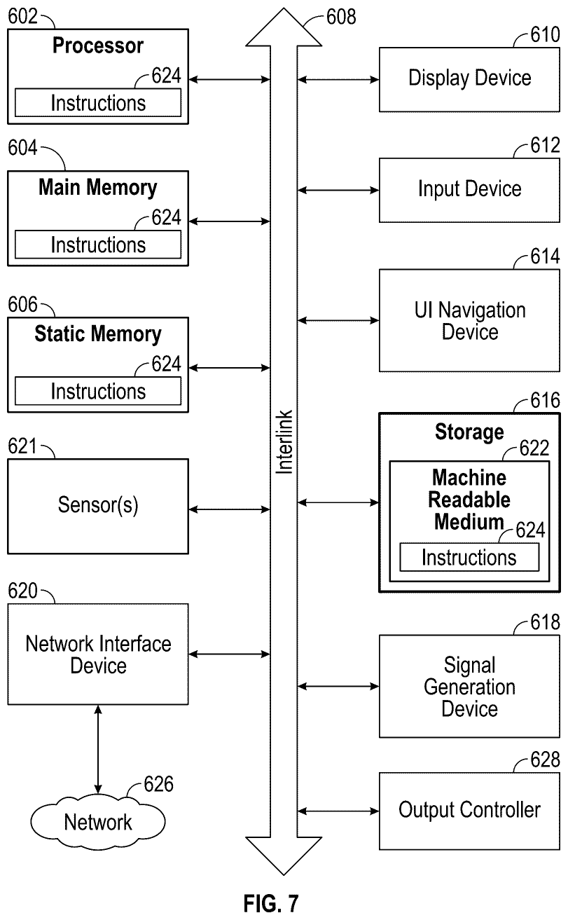

FIG. 7 illustrates generally an example of a block diagram of a machine upon which any one or more of the techniques (e.g., methodologies) discussed herein may perform in accordance with some embodiments. In examples, the machine 700 may include control circuitry or execute instructions associated with controlling lifting columns 108 to alter the tilt, incline, or attitude of a work machine 100, e.g., to maintain a frame axis of the work machine 100 parallel with respect to a cut plane, or at a predefined angle with respect to the cut plane. In alternative embodiments, the machine 700 may operate as a standalone device or may be connected (e.g., networked) to other machines. The machine 700 can provide communication inputs or outputs to operators either remote or local to the work machine 100.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer-readable medium containing instructions, where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, alphanumeric input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, non-contacting sensors (laser, LIDAR, radar, sonar, camera-based) or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine-readable (or computer-readable) medium 722 that is non-transitory on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), a legacy telephone network, and wireless data networks (e.g., Institute of Electrical and Electronics Engineers (IEEE) 802.11family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### INDUSTRIAL APPLICABILITY

The present application describes various systems and methods for controlling inclination of a work machine relative to an operating surface, for example, to control a cold planer machine to keep its frame parallel to the ground and/or the cut plane. One or more non-contacting ground sensors can be used as part of an inclination control system to identify distance to ground or other parameters relative to sensing the ground or other work surface. In at least one example, one or more cameras, LIDARs, or similar is positioned to detect ground height or distance to the work surface proximate side plates (e.g., outside side plates), behind chain guards, along a longitudinal central axis of the work machine or at other locations. Lifting columns can be activated or controlled upon sensing a non-parallel condition or other condition related to the inclination of the work machine, to bring the work machine to a desired inclination.

What is claimed is:

1. A work machine, comprising:
a frame defining a front end and a rear end of the work machine and having a frame axis extending longitudinally therethrough and a rotating drum extending in a direction perpendicular through the frame axis;
a transportation device configured to move the work machine over a ground surface;
a lifting column extending between the frame and the transportation device;
side plates arranged on opposite sides of the work machine;
at least one sensor located laterally outside a width of the work machine defined by the side plates, the sensor configured to detect a feature of the ground surface; and
a controller coupled to the at least one sensor and configured to control the lifting column to control inclination of the work machine based on the detected feature.

2. The work machine of claim 1, comprising a plurality of sensors, wherein at least two of the plurality of sensors are spaced apart along a longitudinal axis.

3. The work machine of claim 2, wherein the at least two sensors are each configured to detect distance between the respective sensor and the ground surface.

4. The work machine of claim 3, wherein the controller is configured to determine whether the frame axis of the work machine is at a target inclination to the ground surface based on the detected distances of each of the at least two sensors.

5. The work machine of claim 3, wherein the controller is configured to determine whether the frame axis of the work machine is parallel to the ground surface based on the detected distances of each of the at least two sensors.

6. The work machine of claim 1, wherein the at least one sensor comprises a Light Detection and Ranging (LIDAR) sensor.

7. The work machine of claim 1, wherein the at least one sensor detects the ground surface inwardly toward a center axis of the work machine.

8. The work machine of claim 1, wherein the at least one sensor detects downward to the ground surface.

9. The work machine of claim 1, wherein the at least one sensor detects the ground surface outwardly away from a center axis of the work machine.

10. An inclination control system including:
at least one sensor adapted to be positioned laterally outside a cut width of a work machine, the at least one sensor configured to detect a feature of a cut plane under the work machine; and
a controller adapted to be coupled to the at least one sensor and configured to control inclination of the work machine based on the detected feature.

11. The inclination control system of claim 10, comprising a plurality of sensors, at least two of the plurality of sensors are spaced longitudinally along an axis.

12. The inclination control system of claim 11, wherein the at least two sensors are each configured to detect distance between the respective sensor and the cut plane.

13. The inclination control system of claim 12, wherein the controller is configured to determine whether a frame axis of the work machine is parallel to the cut plane based on the detected distances of each of the at least two sensors.

14. The inclination control system of claim 10, wherein the at least one sensor comprises a laser device, a radar device, an imaging system, or a sonic device.

15. A work machine comprising:
a frame defining a front end and a rear end of the work machine and having a frame axis extending longitudinally therethrough and a rotating drum extending in a direction perpendicular through the frame axis;
a transportation device configured to move the work machine over a ground surface;
a lifting column extending between the frame and the transportation device;
side plates arranged on opposite sides of the work machine;
at least one non-contacting sensor located on a central axis of the work machine and configured to detect a feature of the ground surface between the side places; and
a controller coupled to the one or more non-contacting sensors and configured to control the lifting column to control inclination of the work machine based on the detected feature.

16. The work machine of claim 15, wherein the at least one non-contacting sensor comprises a plurality of non-contacting sensors spaced apart on the central axis of the work machine.

17. The work machine of claim 15, wherein the at least one non-contacting sensor comprises two non-contacting sensors located forward and rearward of the transportation device.

18. The work machine of claim 17 comprising a pair of transportation devices including the transportation device and a pair of lifting columns including the lifting column, wherein the two non-contacting sensors are located on a longitudinal axis centered laterally between the pair of lifting columns.

19. The work machine of claim 15, wherein the at least one non-contacting sensor comprises ultrasonic sensors.

20. The work machine of claim 15, wherein the at least one non-contacting sensor is configured to detect distance between the respective sensor and the ground surface.
